(19) United States
(12) Patent Application Publication
(10) Pub. No.: US 2010/0211421 A1
(43) Pub. Date: Aug. 19, 2010

(54) AUTOMATIC QUOTE GENERATION FOR CUSTOM CONSTRUCTION PROJECTS

(76) Inventors: Robert A. Sciammarella, Draper, UT (US); Brian David, Sandy, UT (US); Matthew Bennett, Draper, UT (US)

Correspondence Address: Workman Nydegger;1000 Eagle Gate Tower, 60 East South Temple, Salt Lake City, UT, 84111, US

(21) Appl. No.: 12/389,260

(22) Filed: Feb. 19, 2009

(51) Int. Cl. G06Q 30/00; G06Q 10/00; G06Q 50/00; G06F 3/048; G06F 3/00; G06F 3/041

(52) U.S. Cl. 705/7; 705/400; 705/26; 705/27; 715/839; 715/708; 345/173

(57) ABSTRACT

Automatic quote generation for custom construction projects. In one example embodiment, a method for automatically generating a quote for a custom construction project includes various acts. First, a server system receives, from a kiosk system, data corresponding to customer-selected construction materials for use in a custom construction project. Next, the server system transforms the data into an automatically generated cost quote for the custom construction project. Finally, the server system sends, to the kiosk, the quote for display by the kiosk system.

### BACKGROUND

1. The Field of the Invention

The present invention relates to construction projects. More specifically, the present invention relates to automatic quote generation for custom construction projects.

2. Related Technology

Home builders and home remodelers are hired by customers to build and remodel homes according to customer preferences. For example, a homebuilder may be hired to build a new home from the ground up or a home remodeler may be hired to remodel a kitchen or a bathroom in an existing home. Where a building or remodeling project is based on a standard set of plans using standard materials, the cost of the project can be precalculated by a dealer and can be quoted to the customer at the initial consultation with a salesperson employed by the dealer. However, a more common scenario is where the customer's preferences diverge from standard plans and materials, resulting in a custom project. The calculation of costs involved in a custom project is complex and fluctuates based on various factors.

One major source of frustration for customers is the amount of time and effort required to obtain an accurate quote for the cost of a project. For example, after first consulting with a salesperson regarding a custom project, a customer may have to wait several days or weeks before the salesperson can gather sufficient information and perform the complex calculations required to provide an accurate quote. The customer's frustration with this delay can result in lost sales and wasted time and effort on the part of the salesperson. This delay can also harm the relationship between the customer and the salesperson, which may cause the customer to doubt the accuracy of the salesperson's delayed quote.

### BRIEF SUMMARY OF SOME EXAMPLE EMBODIMENTS

In general, example embodiments of the invention relate to systems and methods for automatic quote generation for custom construction projects. In some example embodiments, a quote for the cost of a custom project is automatically and accurately generated based solely on information that is quickly gathered from a customer. This enables the quote to be generated in a matter of minutes instead of a matter of days or weeks. This rapid quote can avoid the frustration associated with a delayed quote and can result in increased sales of custom projects. Even when a sale is lost, this rapid quote can decrease or eliminate entirely the amount of time and effort wasted by a salesperson.

In one example embodiment, a method for automatically generating a quote for a custom construction project includes various acts. First, a server system receives, from a kiosk system, data corresponding to customer-selected construction materials for use in a custom construction project. Next, the server system transforms the data into an automatically generated cost quote for the custom construction project. Finally, the server system sends, to the kiosk, the quote for display by the kiosk system.

In another example embodiment, a kiosk system is configured to automatically generate a quote for custom construction. The kiosk system includes a cabinet, a plurality of compartments at least partially positioned within the cabinet, an electronic visual display positioned on a surface of the cabinet, and an input device in electronic communication with the display. The plurality of compartments are each configured to store samples of construction materials. The electronic visual display is configured to present an image corresponding to each sample construction material. The input device is configured to allow a customer to select one of the images presented on the display. In response to the selection, the display is configured to present the customer with a visual indication of the compartment in which the corresponding sample is stored.

In yet another example embodiment, a kiosk system is configured to automatically generate a quote for a custom construction project. The kiosk system includes an electronic visual display and an input device in electronic communication with an electronic visual display. The kiosk system is configured to receive, from the input device, data corresponding to customer-selected construction materials for use in a custom construction project. The kiosk system is also configured to send the data to a web server. The kiosk system is further configured to receive, from the web server, an automatically generated cost quote for the custom construction project. The kiosk system is finally configured to display the quote on the display.

In still another example embodiment, a kiosk system is configured to automatically generate a quote for a custom kitchen remodel project. The kiosk system includes a cabinet, a plurality of compartments at least partially positioned within the cabinet, a plurality of samples of kitchen cabinet materials stored within the compartments, and a touch screen monitor positioned on a surface of the cabinet. The touch screen monitor is configured to:

i) present an image corresponding to each sample kitchen cabinet construction material;

ii) allow a customer to select one or more of the images presented on the touch screen monitor for use in a custom kitchen remodel project and, in response to the selection, present the customer with a visual indication of the compartments in which the corresponding samples are stored;

iii) send, to a web server, data corresponding to the customer-selected kitchen cabinet materials;

iv) receive, from the web server, an automatically generated cost quote for the custom kitchen remodel project;

v) display the quote on the touch screen monitor;

vi) allow the customer to specify additional data corresponding to a customer-specified layout for the custom kitchen remodel project;

vii) send, to the web server, the additional data;

viii) receive, from the web server, an updated cost quote for the custom kitchen remodel project that was automatically generated using the additional data; and

ix) display the updated quote on the touch screen monitor.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. Moreover, it is to be understood that both the foregoing general description and the following detailed description of the present invention are exemplary and explanatory and are intended to provide further explanation of the invention as claimed.

### BRIEF DESCRIPTION OF THE DRAWINGS

To further clarify certain aspects of the present invention, a more particular description of the invention will be rendered by reference to example embodiments thereof which are disclosed in the appended drawings. It is appreciated that these drawings depict only example embodiments of the invention and are therefore not to be considered limiting of its scope. Aspects of the invention will be described and explained with additional specificity and detail through the use of the accompanying drawings in which:

FIG. 1 discloses an embodiment of a network environment in which clients can communicate with a server during the automatic generation of a quote for a custom construction project;

FIG. 2A is a front plan view of a kiosk system configured to automatically generate a quote for a custom construction project;

FIG. 2B is a front perspective view of the kiosk system of FIG. 2A;

FIGS. 3A and 3B are a flowchart of an example method for automatically generating a quote for a custom construction project; and

FIGS. 4-25 are directed to various displays such as might be presented to a customer during the example method of FIG. 3.

### DETAILED DESCRIPTION OF SOME EXAMPLE EMBODIMENTS

Example embodiments of the present invention relate to systems and methods for automatic quote generation for custom construction projects. Embodiments of the invention may take the form of various software applications that automatically generate quotes for custom construction projects. Embodiments of the invention can be employed for use in connection with various types of construction projects including new home building and existing home remodeling. Though embodiments of the invention may be particularly advantageous in home building and remodeling, the construction of other types of buildings, such as commercial structures, may similarly benefit from these embodiments. For example, embodiments may be employed in connection with custom roofing, siding, or additions, for example.

As used herein, the term “quote” refers to an estimate of the cost of a custom construction project based on information supplied by a customer. A quote can be a range of cost values or may instead be a single cost value. It is understood that a quote can only be as accurate as the information supplied by the customer, and that inaccuracies in the information supplied by the customer will result in inaccuracies in any quote that is based on that information.

Embodiments of the invention can include special purpose and general-purpose computing devices having various computer hardware and software. Embodiments within the scope of the present invention can also include computer-readable media for carrying or having computer-executable instructions or data structures stored thereon. Computer-executable instructions comprise, for example, instructions and data which cause a general purpose computer, special purpose computer, or special purpose processing device to perform a certain function or group of functions.

Computer-readable media, on the other hand, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means or modules in the form of computer-executable instructions or data structures and which can be accessed by a general purpose or special purpose computer.

### 1. Example Network Environment

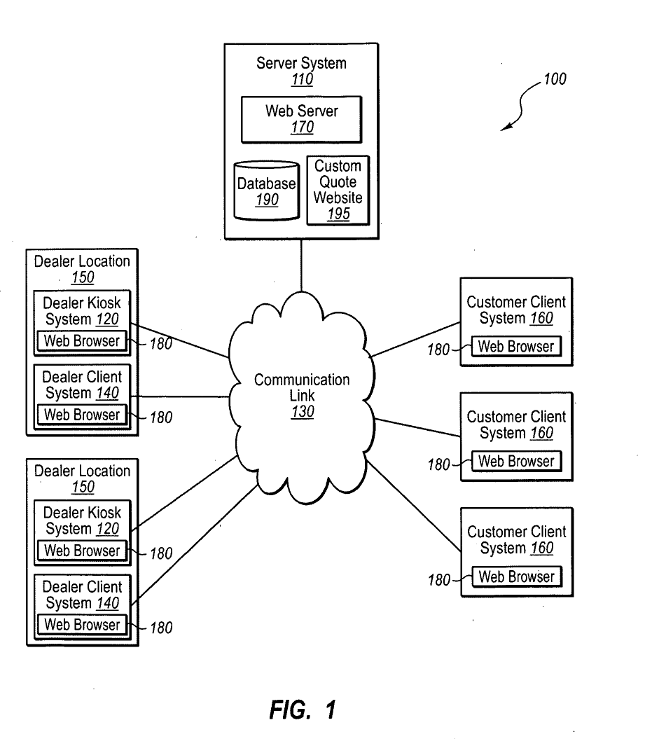

Attention will now be directed to FIG. 1, which discloses a network environment 100 in which example embodiments of the invention can be practiced. As shown, a server system 110 is connected with one or more dealer kiosk systems 120 through a communication link 130. The communication link 130 can be any network connection. According to one embodiment, the communication link includes a LAN, a WAN, and/or the Internet, such that the one or more dealer kiosk systems 120 can communicate with the server system 110 through a LAN, a WAN, and/or the Internet. It is understood that each of the “connections” to the communication link 130 herein can be hardwired, wireless, or a combination of hardwired and wireless connections.

The server system 110 is also shown to be connected with one or more dealer client systems 140 through the communication link 130. As shown in FIG. 1, a dealer kiosk system 120 and a dealer client system 140 may be located in the same dealer location 150. For example, a dealer kiosk system 120 may be located in a dealer's retail showroom where customers can access the dealer kiosk system 120 during regular business hours. The corresponding dealer client system 140 may be located on a nearby desk of a salesperson employed by the dealer. The server system 110 is further shown to be connected with one or more customer client systems 160 through the communication link 130. Each of the customer client systems 160 may be located in a customer's home, for example.

In some example embodiments, the server system 110 can include any combination of computing devices, software, and/or network systems that is/are capable of serving web pages over the Internet to client systems 140 and 160, and to dealer kiosk systems 120 which also function as “client” systems. For example, each of the client systems 120, 140, and 160 can include a computing device having hardware on which world wide web (or simply “web”) server software 170 is installed. In these example embodiments, the client systems 120, 140, and 160 can each include any combination of computing devices, software, and/or network systems that is/are capable of communicating over the Internet with the server system 110. For example, each of the client systems 120, 140, and 160 can include a computing device having hardware on which a web browser 180 is installed. As such, each dealer client system 140 and customer client system 160 may be a mobile device, such as a mobile phone, which includes a web browser 180

According to one embodiment, the server system 110 can further include a database 190 and a custom quote website 195. The database 190 can be preloaded with general project cost information such as the cost of materials, specific material configurations, and labor, as well as formulas for combining general cost information with a specific project's cost information in order to automatically generate a quote for the specific project. The custom quote website 195 can, in combination with the web server software 170, receive information about a specific custom construction project from one or more of the client systems 120, 140, and 160, combine the project-specific information with the general project cost information, according to the formulas mentioned above for example, in order to automatically generate a quote for the cost of the projects, and then send each quote to the corresponding the client system 120, 140, or 160.

The database 190 is currently shown to be incorporated within the server system 110. Nevertheless, it will be appreciated that the database 190 can include remote data storage as well as local data storage. Likewise, it will also be appreciated that the database 190 can include any combination or quantity of computer-readable media. The database 190 may include a variety of different data structures including, but not limited to tables, lists, associative arrays, and tree data structures. The database 190 may further comprise software, dedicated hardware, and/or a combination of software and dedicated hardware. The database 190 may further be configured as a primary database or a backup database on a primary or backup server.

### 2. Example Kiosk System

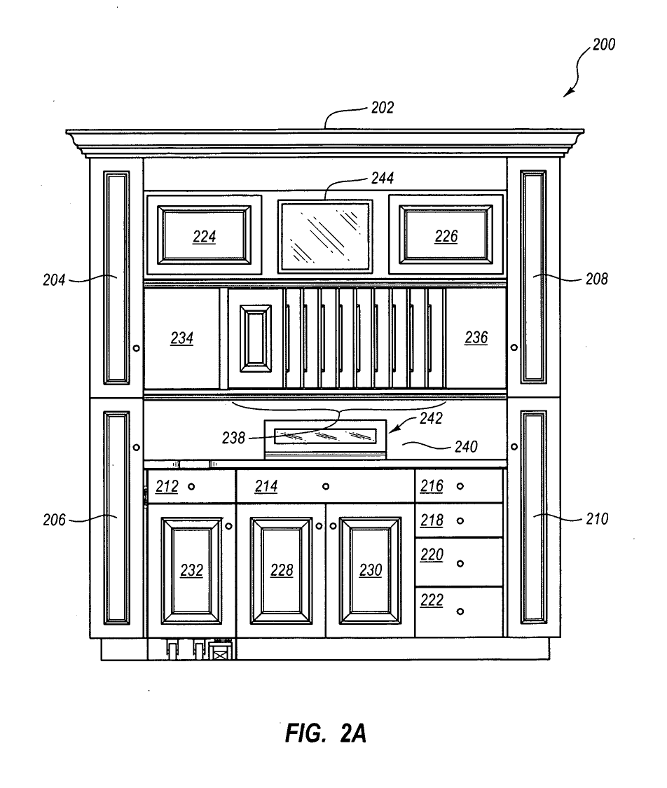

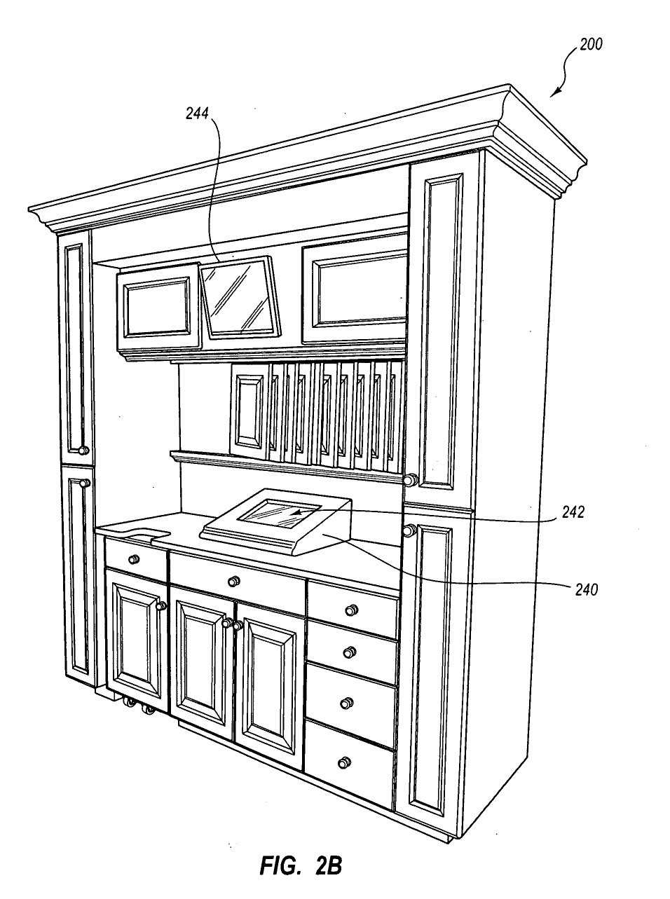

Reference is now made to FIGS. 2A and 2B, which disclose one example embodiment of a kiosk system 200 which can be used in connection with the systems and methods disclosed herein. For example, the kiosk system 200 may be configured with the functionality disclosed herein in connection with each of the dealer kiosk systems 120.

As disclosed in FIGS. 2A and 2B, the kiosk system 200 includes a cabinet 202, a plurality of compartments 204-232 at least partially positioned within the cabinet 202, tipdowns 234 and 236 and pivoting sample doors 238 attached to the cabinet, a first electronic visual display 240 positioned on a surface of the cabinet 202, an input device in electronic communication with the first electronic visual display 240, and a second electronic visual display 242 positioned on another surface of the cabinet 202.

The compartments 204-236 include pullouts 204-210, drawers 212-222, cupboards 224-230, and rollout 232. Each of the compartments 204-232 is configured to store samples of construction materials. For example, where the kiosk system 200 is configured to facilitate the sale of custom kitchen and/or bathroom construction projects, the compartments 204-232 may be configured to samples of door styles, surface finishes, wood species, countertop styles and finishes, as well as organization accessories, cabinet enhancements, crown molding styles, and railing styles. The tipdowns 234 and 236 may also display sample construction materials, and the pivoting sample doors 238 may themselves be samples of cabinet doors of various styles, wood species, and wood finishes.

In addition, the compartments 204-232 may themselves be samples of the styles of compartments that can be included in a custom construction project, such as drawers, cupboards, pullouts, and rollouts. In addition, one or more of the compartments 204-232 may include a transparent covering that enables internal hardware of the compartment to be viewed. For example, the rollout 232 may include a clear glass or plastic covering that enables internal hardware of the rollout 232 to be viewed, such as wood species, hinges, and rollers, for example. The clear glass or plastic covering can also enable the internal construction of the rollout 232 to be viewed.

The first electronic visual display 240 is configured to present an image corresponding to each sample construction material discussed above. For example, the first electronic visual display 240 can be a flat screen computer monitor that is in communication with a desktop computer (not shown) that is hidden within the cabinet 202. A web browser application may be installed on the desktop computer. The web browser application may be configured to communicate with a website that includes one or more images of each sample construction material discussed above.

The input device 242 may be any type input device, such as a keyboard, mouse, or speech recognition system, for example. As shown in FIGS. 2A and 2B, however, the first electronic visual display 240 is a touch screen monitor, and the input device 242 is the touch screen of the touch screen monitor. The input device 242 is configured to allow a customer to select one of the images presented on the display 240. In response to the selection, the display 240 is configured to present the customer with a visual indication of the compartment 204-232 in which the corresponding sample is stored. For example, each of the compartments can be labeled with one or more numbers and/or letters, and the display 240 can be configured to present the label corresponding to a selected sample to enable the customer to easily identify the location of the selected sample.

The second electronic visual display 244 may also be a flat-screen monitor. The display 244 may also be in communication with a desktop computer (not shown). The display 244 may be employed in connection with the display 240. For example, when a customer selects one of the images presented on the display 240, the display 244 may be configured, in response to the selection, to present the customer with a tutorial regarding manufacture of the corresponding construction material. The tutorial can be employed to educate the customer on how the construction material is produced and persuade the customer as to why the customer should choose the particular construction material over other construction materials. For example, if the selected image corresponds to a particular type of cabinet, the tutorial may present a video to the customer on how the cabinet is produced; from the harvesting of the wood for the cabinet, to the building of the cabinet, to the planting of a new tree to replace the harvested wood. The display 244 may also be used to display “help” information when a help button is selected by a customer on the display 240.

### 3. Example Method For Automatically Generating A Quote

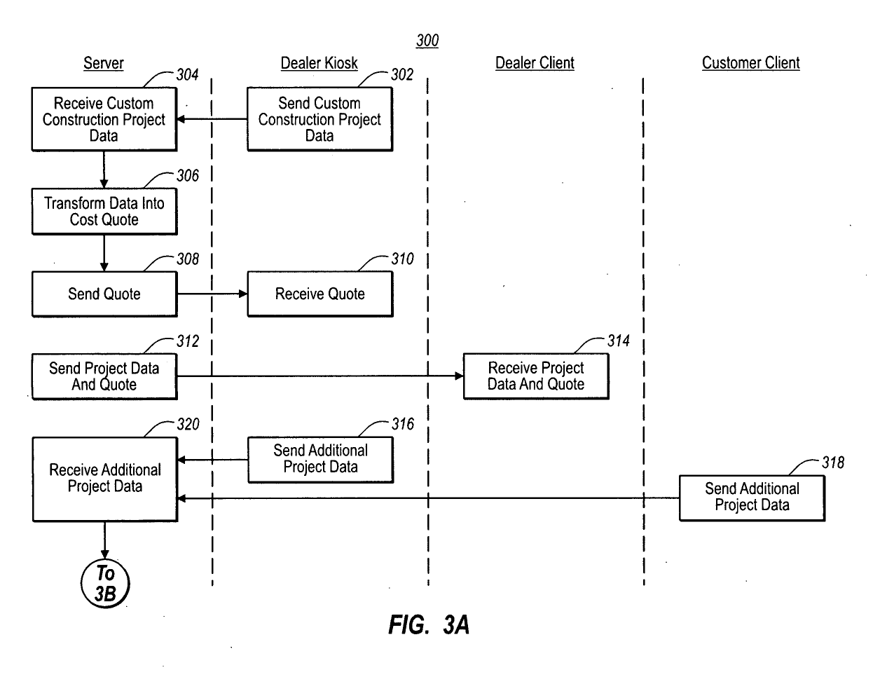

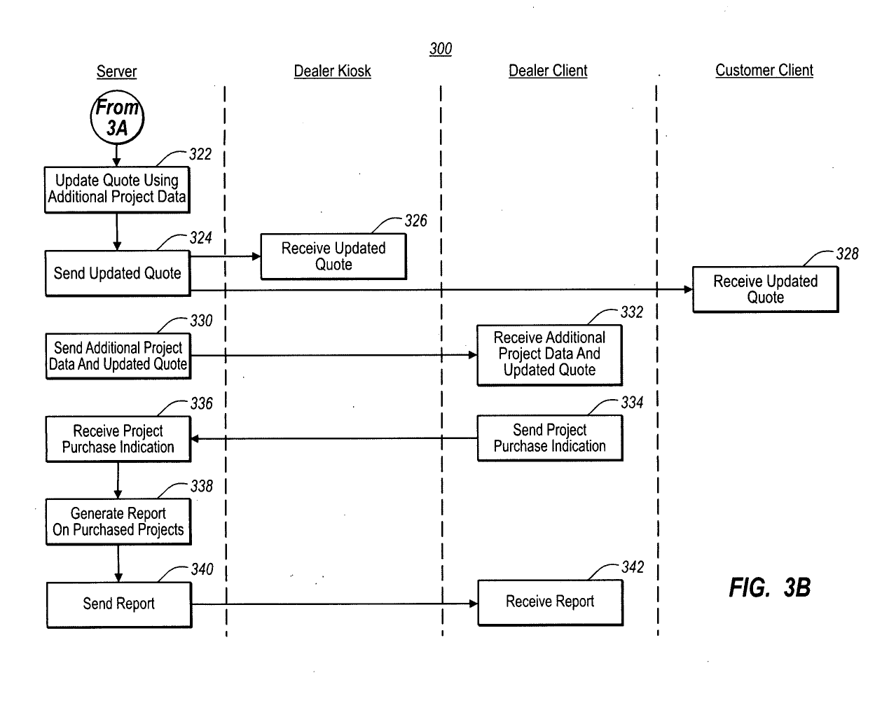

FIGS. 3A and 3B, which will now be described, illustrates a flowchart of a first example method 300 for automatically generating a quote for a custom construction project. The example method 300 may be employed in connection with the network environment 100 of FIG. 1 and the kiosk system 200 of FIGS. 2A and 2B. It is understood, however, the acts of the method 300 can also be accomplished by a kiosk system 200 that does not include the compartments and samples included in the kiosk system 200. For example, the method 300 may be accomplished by a kiosk system that includes nothing more than a web-enabled client system with a touch-screen monitor. Further, the method 300 may be also accomplished by a kiosk system that comprises a mobile device, such as a tablet computer or personal digital assistant (PDA), that can enable a customer to walk between various displays of sample construction materials while selecting corresponding images on the mobile device. The various acts of the method 300 will now be described in turn.

The first illustrated act of the example method 300 includes a web-enabled kiosk system sending data corresponding to a custom construction project (act 302). As used herein, the term “web-enabled” refers to a system or device that is capable of communication over the world wide web (or simple the “web”). Next, a server system receives the custom construction project data (act 304). Next, the server system transforms the data into an automatically generated cost quote for the custom construction project (act 306). Then, the server system sends the quote (act 308) and the kiosk system receives the quote for display by the kiosk system (act 310). Subsequently, the server system sends (act 312) and a dealer client system receives (act 314) the custom construction project data and the cost quote.

Thereafter, the kiosk system sends (act 316) and/or a customer client sends (act 318) additional data corresponding to the custom construction project. Then, the server system receives the additional project data (act 320), updates the cost quote using the additional project data (act 322), and sends the updated cost quote to the kiosk system (act 324). Next, the kiosk system receives (act 326) and or the customer client system receives (act 328) the updated quote for display on the system(s). Afterward the server system sends (act 330) and the dealer client receives (act 332) the additional data and the updated cost quote for display on the dealer client system.

Thereafter, the dealer client system sends (act 334) and the server system receives (act 336) an indication that the custom construction project has been purchased by the customer. The server system then generates a report that compares the number of automatically generated quotes to the number of custom construction projects purchased (act 338). The server system then sends (act 340) and the dealer client system receives (act 342) the report for display on the dealer client system.

### 4. Example Embodiment of the Example Method

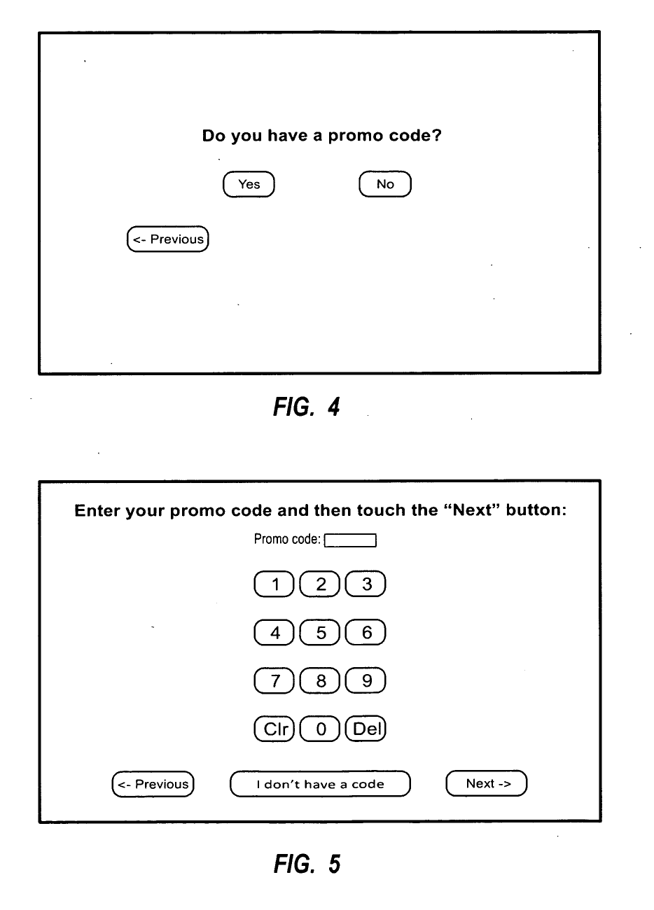

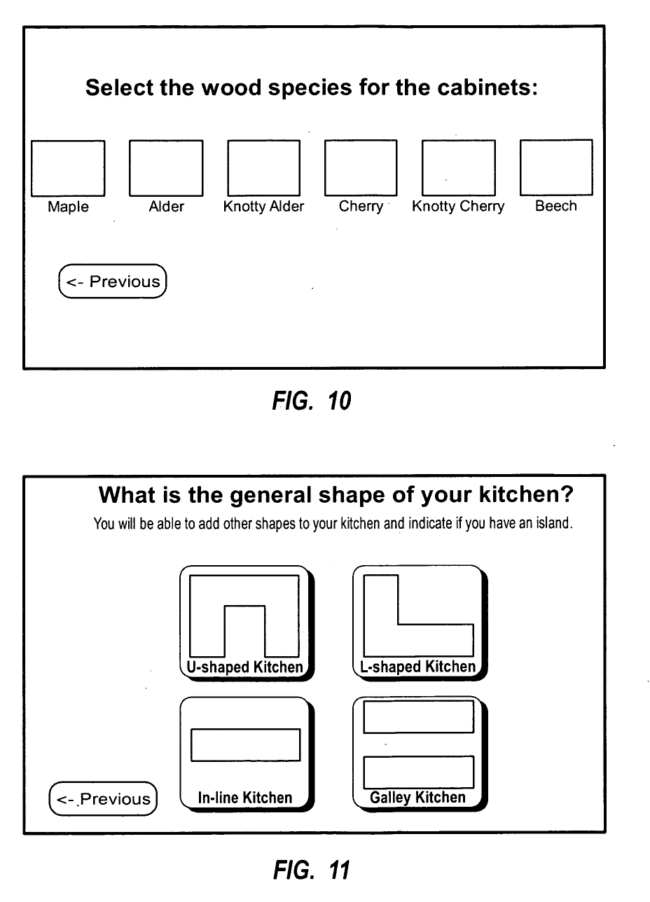

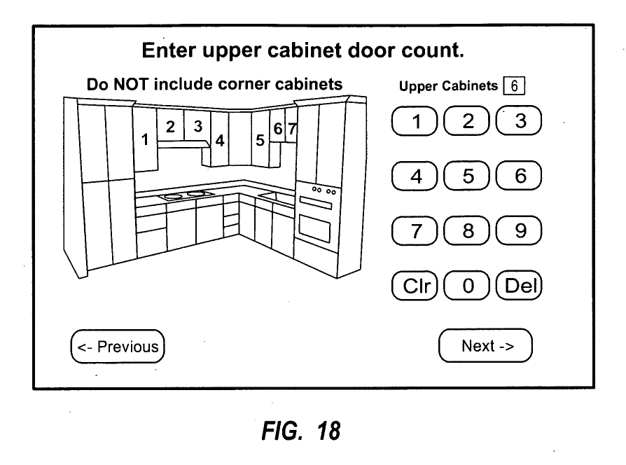

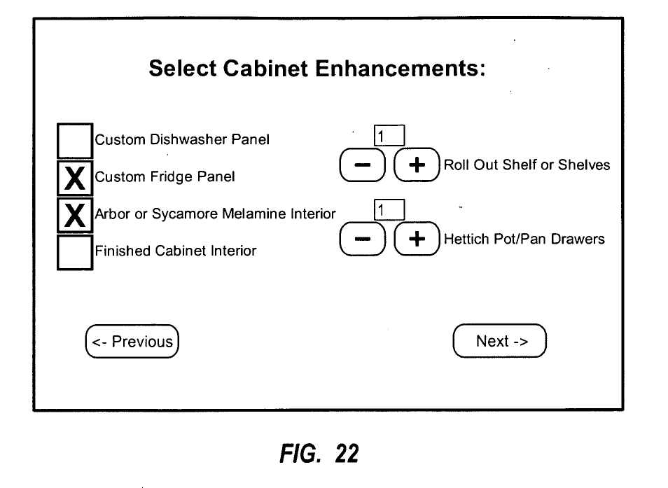

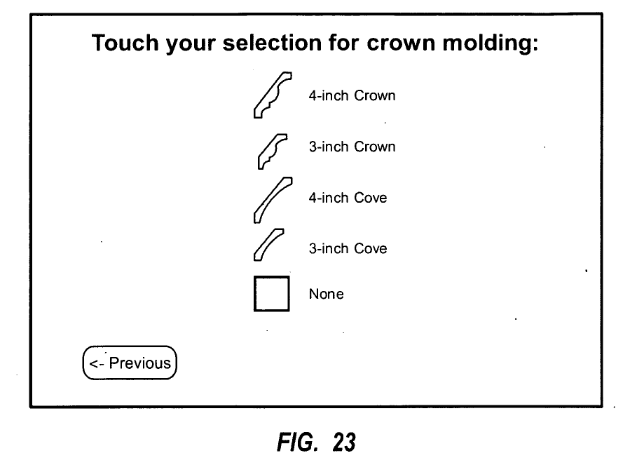

An example embodiment of the example method 300 will also be described with reference to FIGS. 1, 2A, and 2B, and also with reference to the various displays of FIGS. 4-25. The end result of the example embodiment is the automatic generation of a cost quote for a customer's customer construction project, which in this case is a kitchen remodel project. In the example embodiment, at act 302, the web browser 180 of one of the dealer kiosk systems 120 sends, and at act 304 the website 195 receives, data corresponding to a custom construction project. The custom construction project data may include, for example, customer-selected construction materials and/or a customer-specified construction layout.

Acts 302 and 304 can be accomplished, for example, by a customer clicking through a welcome screen and then selecting the “Yes” button or the “No” button on the example display of FIG. 4. If the customer selects the “Yes” button, the customer is presented with the display of FIG. 5, which enables the customer to enter a previously-obtained promotional code. The promotional code may be provided to the customer to adjust all or part of the quote provided to the customer by a predetermined percentage. For example, a promotional code may be provided to a customer to reduce the customer's cost quote by 10%. Alternatively, the promotional code may increase the customer's cost quote by 20%.

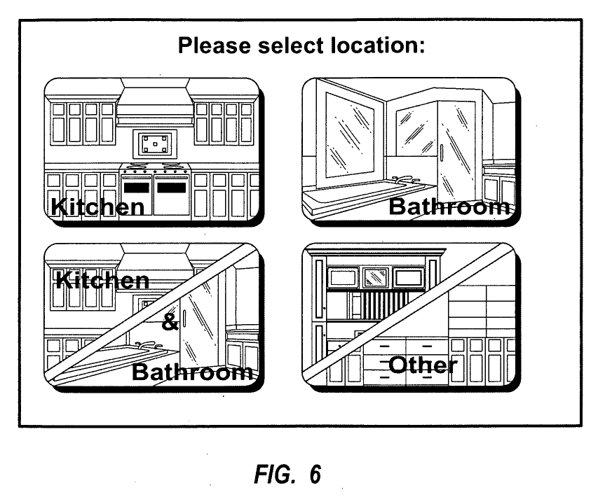

Further, the promotional code may correspond to multiple tiers of margins for the various parties involved in the sale of custom construction projects. For example a particular promotional code may correspond to a 10% margin for the dealer, a 10% margin for the manufacturer of the construction materials used in the project, and a 10% margin for the builder or installer who actually performs the labor on the project. If one or more of these parties wishes to adjust one or more of these margins for a particular customer, the customer can simply be provided with a new promotional code corresponding to the adjusted margins. For example, if the dealer wishes to discount his margin by 2% for a particular customer, the customer can be provided with a new promotional code that designates a 10% margin for the manufacture, a 10% margin for the builder/installer, but only an 8% margin for the dealer. Thus, by providing customers with preconfigured promotional codes, the margins of the parties can be easily and automatically adjusted in the method 300. After the promotional code is entered on the display of FIG. 5, or if the customer selected the “No” button on the display of FIG. 4, the customer is next presented with the display of FIG. 6.

The display of FIG. 6 allows the customer to select from a custom kitchen project, a custom bathroom project, a combination kitchen/bathroom project, or some other type of custom construct project. It is understood, of course, that the display of FIG. 6 could instead present a variety of other types of custom construction projects to a customer, such as a new home construction, a home addition, and/or a commercial construction project, for example. Regardless of the type of project selected on the display of FIG. 6, the customer may next be presented with the display of FIG. 7, which allows the customer to indicate the level of detail the customer is prepared to provide about the desired customer construction project.

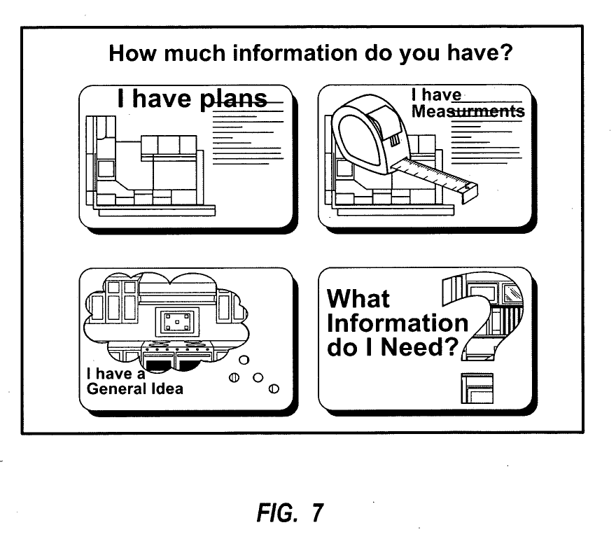

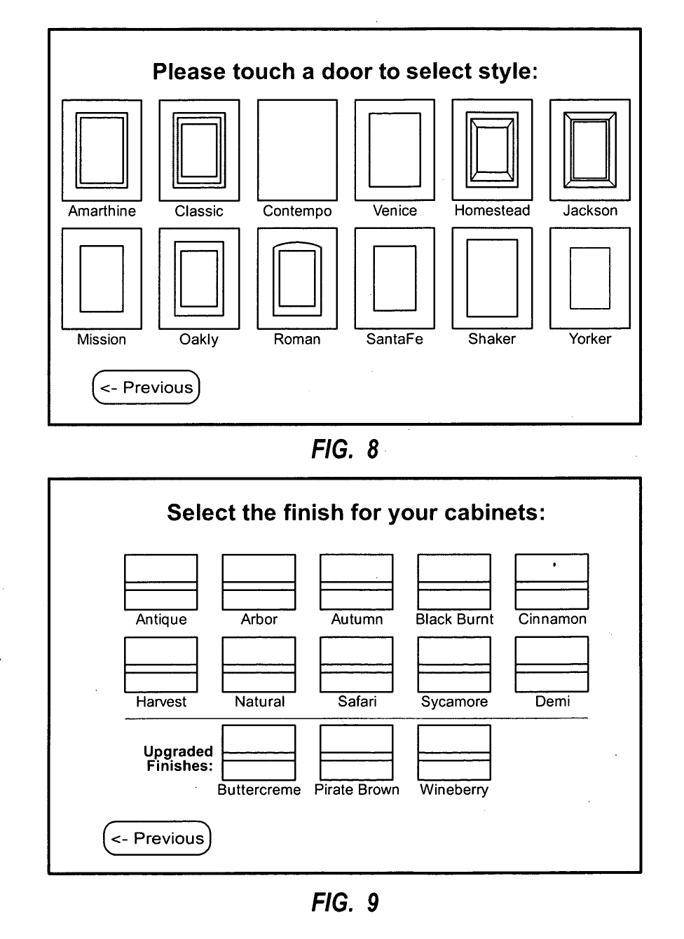

For example, the display of FIG. 7 allows the customer to select one of “I have plans,” “I have measurements,” “I have a general idea,” band “What information do I need?”. When the customer has actual plans or actual measurements for the project, an employee of the dealer may be automatically alerted to go to the location of the kiosk system to assist the customer in submitting the details of the plans to the website 195. When the customer selects the “What information do I need?” button, a “help” screen may appear to walk to customer through the necessary information for the project, or an employee of the dealer may be automatically alerted to go to the location of the kiosk to inform the customer what information is necessary for the project. When the customer selects the “I have a general idea” button, the customer can next be presented with the displays of FIGS. 8-18 to enable the customer to enter enough detail to provide a cost quote for the project.

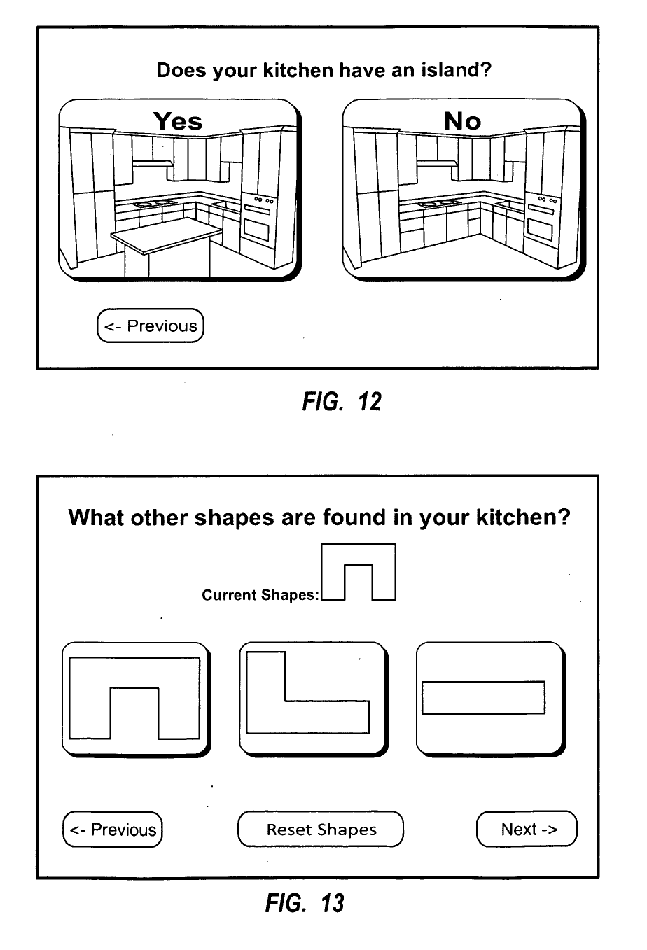

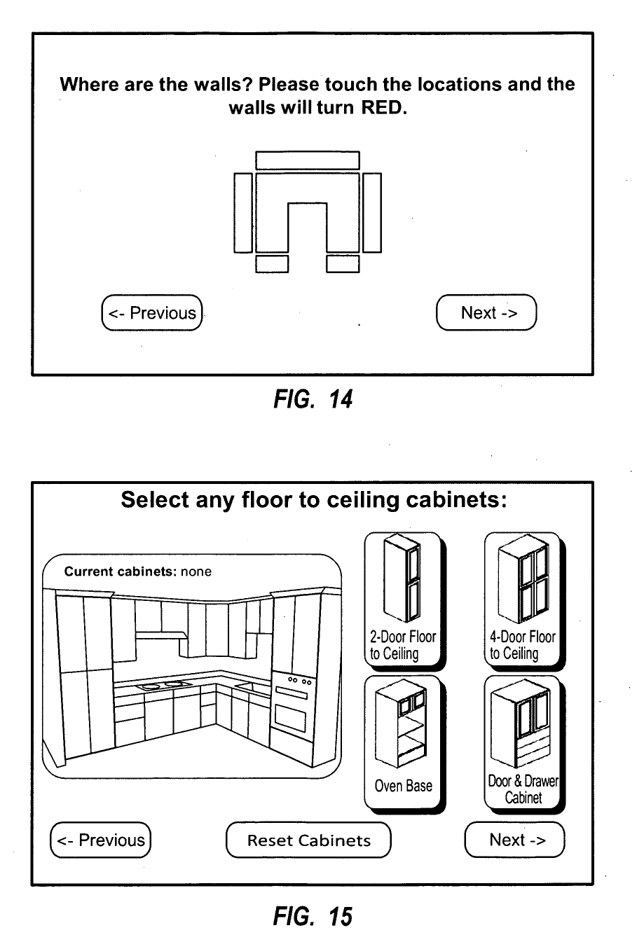

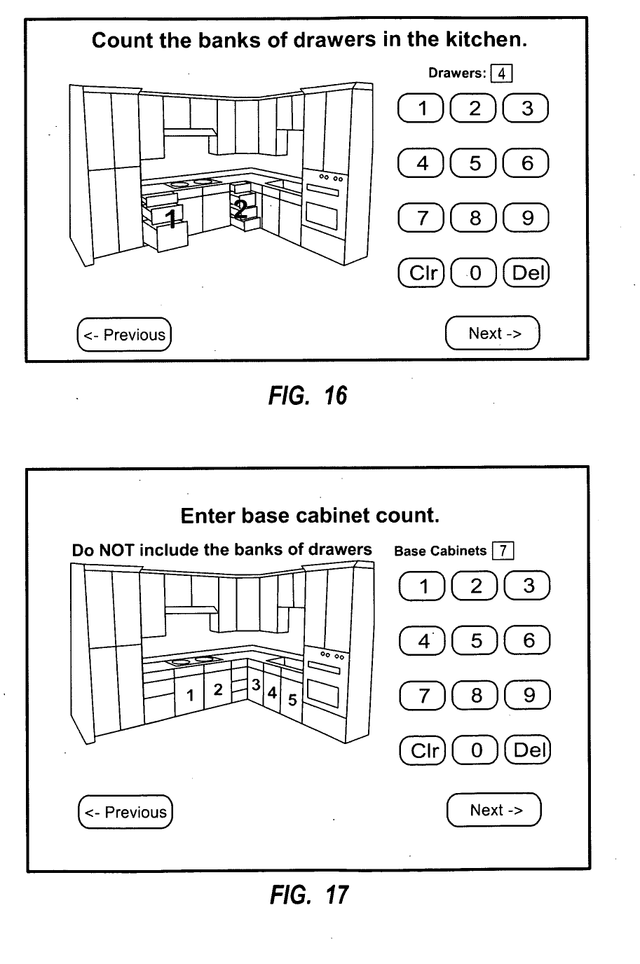

The displays of FIGS. 8-10 allow the customer to select a door style, a surface finish, and a wood species for cabinets in a kitchen project, respectively. The display of FIG. 11 allows the customer to designate the shape of his kitchen. The display of FIG. 12 enables the customer to specify if the customer has an island in his kitchen. The display of FIG. 13 enables the customer to designate one or more other shapes found in his kitchen. The display of FIG. 14 permits the customer to specify the locations of the walls with respect to the shape of his kitchen. The display of FIG. 15 allows the customer to designate the style of any floor-to-ceiling cabinets in his kitchen. The displays of FIGS. 16-18 enable the customer to specify the number of banks of drawers, base cabinets, and upper cabinets in his kitchen, respectively.

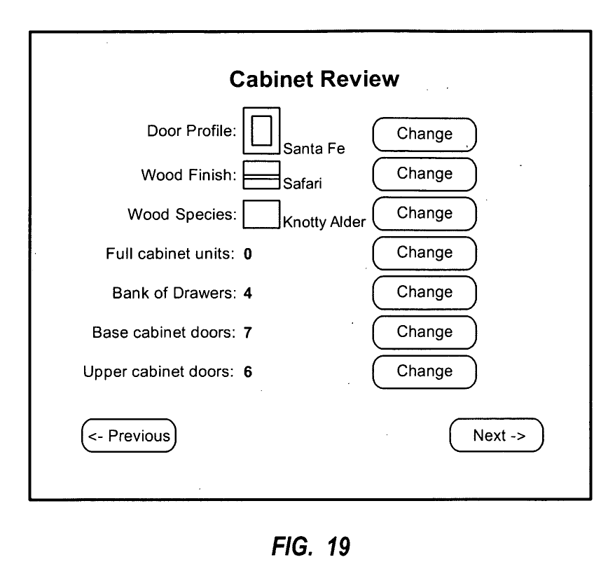

After the website 195 presents the customer with the displays of FIGS. 4-18, the website 195 is presented with the review display of FIG. 19 which allows the customer to change any of the previously selected or designated parameters of the customer's kitchen. Thus, using the displays of FIGS. 4-19, the acts 302 and 304 can be accomplished.

Continuing with the example embodiment, at act 306, the website 195 of the server system 110 transforms the custom construction project data into an automatically generated cost quote for the custom construction project. For example, the website 195 may automatically query the database 190 to retrieve preloaded construction material costs, labor costs, as well as formulas for combining general cost information with customer-selected construction materials and/or a customer-specified construction layout. Examples of customer-selected construction materials and customer-specified construction layouts were discussed above in connection with the displays of FIGS. 4-19. The website 195 may then transform the customer-selected construction materials and/or customer-specified construction layout using these retrieve formulas in order to transform the custom construction project data into an automatically generated cost quote for the custom construction project.

This transformation may be accomplished, for example, by computing the total amount of construction materials, determining the cost of those construction materials, computing the total hours of labor the construction project will require, determining the cost of those labor hours, and finally adding together the costs of all construction materials and/or labor that will be necessary to complete the construction project. It is understood that the method 300 may be employed to sell only the construction materials for a project where the customer desires to handle the labor separately.

This transformation may also include calculating the costs of all construction materials and/or labor for one or more of the dealer's competitors so that the final quote can include quotes from the dealer and from one or more of the dealer's competitors. This enables the customer to easily compare the dealer and the dealer's competitors to determine whether it is cost effective to purchase the custom construction project from the dealer. The calculating of a competitor's project cost can be accomplished by storing, in the database 190, the price charged by the competitor for certain construction materials, as well as the way in which the layout of the project affects those costs. For example, a certain cabinet may have a higher cost when the cabinet is installed as a corner cabinet as opposed to when the cabinet is installed in the middle of a straight row of cabinets. This higher can be due to a higher cost of the cabinet itself with a corner configuration and/or a higher cost of the labor to install the cabinet in the corner.

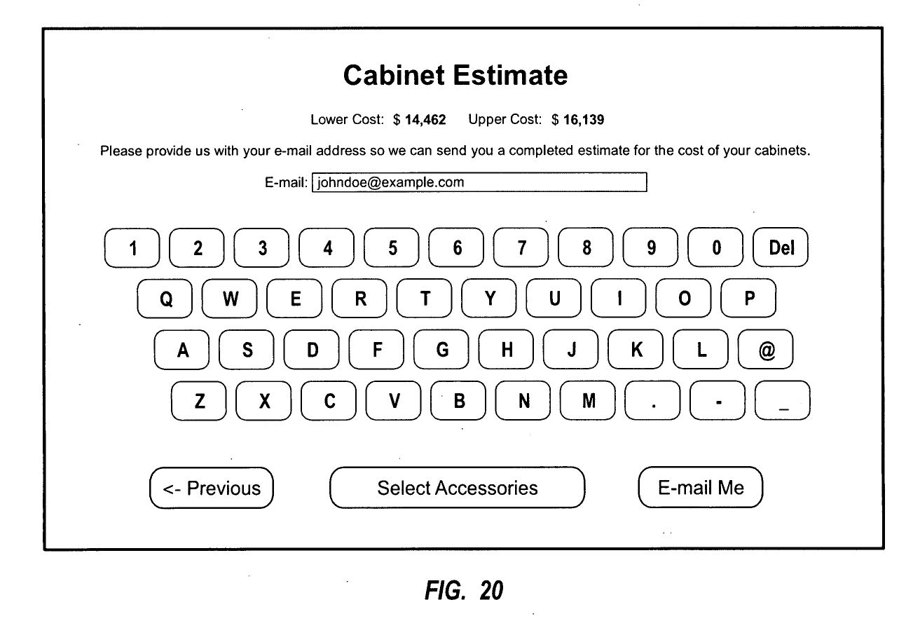

Continuing with the example embodiment, at act 308, the website 195 sends, and at act 310 the web browser 180 of the kiosk system 120 receives, the quote for display by the kiosk system 120. For example, the kiosk system 120 may be configured similar to the kiosk system 200, and the quote may be displayed in a web browser 180 on the touch screen monitor 240 of the kiosk system 200. Acts 308 and 310 can be accomplished, for example, by the website 195 sending, and the web browser 180 receiving and presenting, the display of FIG. 20 on the touch screen monitor 240 of the kiosk system 200.

As shown in FIG. 20, the cost quote based on the customer-specified information shown on the display of FIG. 19 is a range of cost values, specifically between $12,826 and $14,447. It is understood that the cost quote may instead be a single cost value, such as $13,200. Also shown in FIG. 20 is the ability for the customer to enter an email address to which the cost quote will be emailed. This email may include a link that can enable the customer to access the website 195 through a system other than the kiosk system 120, such as the customer client system 160 located at the customer's home, for example.

Thus, the cost quote shown on the display of FIG. 20 is automatically and accurately generated based solely on information readily available to a customer. This enables the quote to be generated in a matter of minutes instead of a matter of days or weeks. For example, the cost quote on the display of FIG. 20 may be generated in about seven minutes on average. This rapid quote generation can avoid the frustration associated with a delayed quote and can result in increased sales of custom construction projects. Also, some customers inherently have more confidences in this computer-generated and computer-presented cost quote as compared to a cost quote generated or presented by a human salesperson.

As noted above, the price quote received at 310 may include a quote from the dealer as well as quotes from one or more of the dealer's competitors. This enables the customer to easily compare the dealer and the dealer's competitors to determine whether it is cost effective to purchase the custom construction project from the dealer. Sending and receiving competitor's quotes may further aid the dealer is selling other goods or services to the customer. For example, the dealer may charge a membership fee up front before a customer is allowed to purchase a custom construction project from the dealer. Where the price quote received at 310 includes quotes from the dealer and from one or more of the dealer's competitors, and the price of the dealer's membership added to the dealer's quote is still less than the competitor's quote, the dealer can easily persuade the customer to purchase both the membership fee and the custom construction project from the dealer.

Continuing with the example embodiment, at act 312, the website 195 of the server system 110 sends, and at act 314 the web browser 180 of the dealer client system 140 receives, the custom construction project data and the cost quote. The acts 312 and 314 can alert a salesperson employed by the dealer that a customer has accessed the kiosk system 120 and has received a quote for the customer construction project. The salesperson can also receive contact data corresponding to the customer, such as the email address entered by the customer on the display of FIG. 20. This project data, cost quote, and contact data can be sent by the website 195 in an email, or the email can link to a web page that contains the data and quote that can be displayed in the web browser 180 of the dealer client system 140, for example. The salesperson can then use this received information to contact the customer and attempt to convert the cost quote into a sale of the custom construction project. Thus, the method 300 can generate leads for the dealer with little or no manpower expended by the dealer. Even when the lead does not result in a sale, the method 300 can decrease or eliminate entirely the amount of time and effort wasted by a salesperson in the initial generation of the lead.

Continuing with the example embodiment of the method 300, at act 316, the web browser 180 of one of the dealer kiosk systems 120 sends, and/or at act 318 the web browser 180 of one of the customer client systems 120 sends, additional data corresponding to the custom construction project. Then, at act 320, the additional project data is received by the website 195 of the server system 110. For example, where the data received at act 304 included customer-selected construction materials, but did not include a customer-specified construction layout, the additional data received at act 320 might include a customer-specified construction layout.

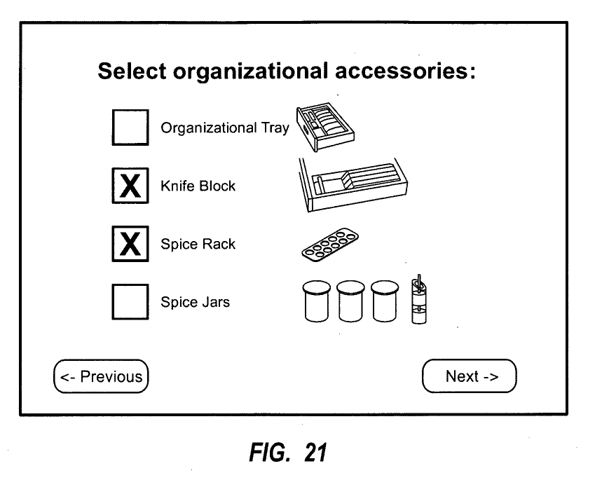

For example, a customer may enter complete and accurate information into only some of the displays of FIGS. 4-18. However, upon further consideration, the customer may later realize that some of the information was incomplete and/or inaccurate. Therefore, the customer may wish to update/changes some of the information entered into one or more of the display of FIGS. 4-18, and review the updates/changes using the display of FIG. 19. In addition, the customer may further wish to add to his custom construction project such as organization accessories, cabinet enhancements, and crown molding using the displays of FIGS. 21-23, respectively. These displays can be accessed by the customer while still standing at the kiosk system 200.

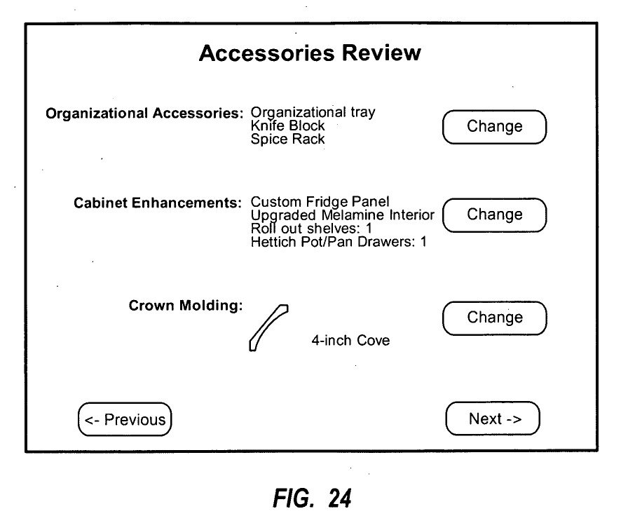

Alternatively, the customer can access these displays from a customer client system 160 after the customer has left the dealership. For example, the website 195 may send an email to the customer that the customer can access from the customer client system 160. The email may include a link that takes the customer back to the website 195 through the web browser 180 of the customer client system 160. Thus, the customer can access the website through the kiosk system 120 or through the customer client system 160. The customer can then review these additions to his project using the display of FIG. 24.

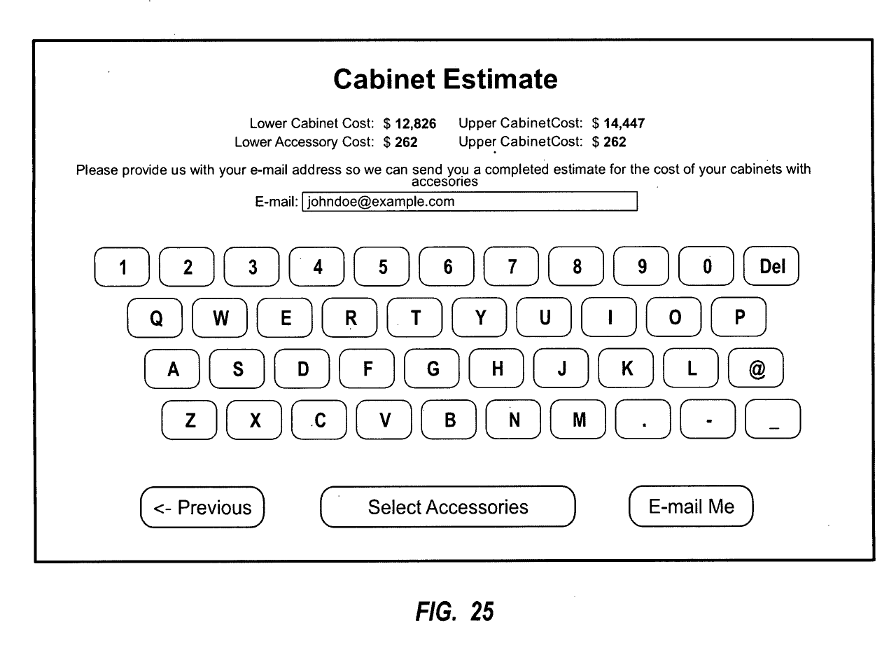

Continuing with the example embodiment, at act 322, the website 195 of the server system 110 automatically updates the cost quote that was previously generated at act 306. Then, at act 324, the website 195 sends, and at act 326 the web browser 180 of the kiosk system 120 receives, and/or at act 328 the web browser 180 of the customer client system 160 receives, the updated quote for display by the system(s) 120 and/or 160. For example, the customer may view an updated version of the display of FIG. 20 or view the display of FIG. 25. The additional data provided by the customer may also enabled the website 195 to narrow the price quote from a range of cost values to a single cost value. As noted above in connection with act 308-312, the updated quote of acts 322-326 may also include quote(s) from one or more of the dealer's competitors.

Continuing with the example embodiment, at act 330, the website 195 of the server system 110 sends, and at act 332 the web browser 180 of the kiosk system 120 receives, the custom additional construction project data and the updated cost quote. The acts 330 and 332 may be accomplished, and may have similar results, as those discussed above in connection with the acts 312 and 314.

Continuing with the example embodiment, at act 334, the browser 180 of the dealer client system 140 sends, and at act 336 the website 195 of the server system 110 receives, an indication that the custom construction project has been purchased by the customer. Alternatively, at act 334, another client system, such as one of the customer client systems 160 may send the indication that the custom construction project has been purchased by the customer, as well as other pertinent information about the project, such as the final cost of the project for example. This indication can also be send to the website 195 by another party to the transaction, such as an installer/builder or a manufacturer. This indication can then be stored, for example, in the database 190 of the server system 110. The tracking of sales information in the database 190 enables the website 195 to automatically adjust its quotes where the website 195 determines that the quotes being generated are not accurate. For example, if the final cost of projects is consistently either higher or lower than the ranges of the quotes being generated for those projects, then the website 195 can automatically adjust the ranges of future quotes accordingly to compensate and thereby make the ranges of quotes more accurate.

At act 338, the website 195 next generates a report that compares the number of automatically generated quotes to the number of custom construction projects purchased. The report can also give details as to what types of construction materials are popular with customers. Finally, at act 340 the website 195 sends the report, and at act 342 the browser 180 of the dealer client system 160 receives the report. This report can enable the dealer to track the benefits of employing the kiosk system 120 in the dealer's business. This report can also allow the dealer to refine the options offered to customers by the kiosk system 120.

Thus, in the example embodiment of the example method 300 disclosed above, the sale and tracking of a custom construction project can be accomplished. This sale and tracking can be accomplished rapidly and accurately resulting in an overall positive experience for the customer and increase in profits for the dealer.

Although some of the example embodiments of the method 300 are disclosed in connection with web-enabled systems, it is understood that various acts of the method 300 may alternatively be accomplished by a stand-alone system in which the client and server functionalities described herein are performed by a single computing device without communication over the Internet.

The example embodiments disclosed herein may be embodied in other specific forms. The example embodiments disclosed herein are to be considered in all respects only as illustrative and not restrictive.

What is claimed is:

1. A method for automatically generating a quote for a custom construction project, the method comprising:
i) receiving, from a kiosk system, data corresponding to customer-selected construction materials for use in a custom construction project;
ii) transforming the data into an automatically generated cost quote for the custom construction project; and
iii) sending, to the kiosk system, the quote for display by the kiosk system.

2. The method as recited in claim 1, wherein the cost quote comprises a range of cost values.

3. The method as recited in claim 1, wherein the cost quote comprises a range of cost values for a dealer as well as a range of cost values for a competitor of the dealer.

4. The method as recited in claim 1, wherein i) further comprises receiving, from the kiosk system, additional data corresponding to a customer-specified construction layout for the custom construction project.

5. The method as recited in claim 1, further comprising:
iv) receiving, from a web-enabled client system, additional data corresponding to a customer-specified construction layout for the custom construction project;
v) updating the cost quote for the custom construction project using the additional data; and
vi) sending, to the client system, the updated quote for display by the client system.

6. The method as recited in claim 1, wherein i) further comprises receiving, from the kiosk system, contact data corresponding to the customer and a promotional code that corresponds to a set margin for the dealer.

7. The method as recited in claim 6, further comprising:
sending, to a web-enabled client system, a notification of the generation of the quote including the contact data for display by the client system.

8. The method as recited in claim 1, further comprising:
iv) receiving, from a web-enabled client system, an indication that the custom construction project has been purchased;
v) automatically generating a report that compares the number of automatically generated quotes to the number of custom construction projects purchased; and
vi) sending, to the web-enabled client system, the report for display on the client system.

9. The method as recited in claim 8, wherein the report generated at v) further includes the customer-selected construction materials corresponding to each custom construction project.

10. A kiosk system configured to automatically generate a quote for custom construction, the kiosk system comprising:
a cabinet;
a plurality of compartments at least partially positioned within the cabinet and configured to store samples of construction materials;
an electronic visual display positioned on a surface of the cabinet, the electronic visual display configured to present an image corresponding to each sample construction material; and
an input device in electronic communication with the display, wherein the input device is configured to allow a customer to select one of the images presented on the display and, in response to the selection, the display is configured to present the customer with a visual indication of the compartment in which the corresponding sample is stored.

11. The kiosk system as recited in claim 10, further comprising:
a second electronic visual display positioned on a surface of the cabinet.

12. The kiosk system as recited in claim 10, wherein the electronic visual display is a touch screen monitor, and the input device is the touch screen of the touch screen monitor.

13. The kiosk system as recited in claim 10, wherein at least one of the compartments includes a transparent covering that enables internal hardware of the compartment to be viewed.

14. The kiosk system as recited in claim 10, wherein the input device is further configured to allow a customer to select an image of a compartment presented on the display and, in response to the selection, the display is configured to present the customer with a visual indication of the corresponding compartment.

15. A kiosk system configured to automatically generate a quote for a custom construction project, the kiosk system comprising:
an electronic visual display, and
an input device in electronic communication with an electronic visual display,
wherein the kiosk system is configured to:
i) receive, from the input device, data corresponding to customer-selected construction materials for use in a custom construction project;
ii) send, to a web server, the data;
iii) receive, from the web server, an automatically generated cost quote for the custom construction project; and
iv) display the quote on the display.

16. The kiosk system as recited in claim 15, wherein the cost quote comprises a range of cost values.

17. The kiosk system as recited in claim 15, wherein the kiosk system is further configured to receive, from the input device, additional data corresponding to a customer-specified construction layout for the custom construction project.

18. The kiosk system as recited in claim 17, wherein the kiosk system is further configured to:
v) send, to the web server, the additional data;
vi) receive, from the web server, an updated cost quote for the custom construction project that was automatically generated using the additional data; and
vii) display the updated quote on the electronic visual display.

19. The kiosk system as recited in claim 15, wherein the kiosk system is further configured to receive, from the input device, contact data corresponding to the customer.

20. The kiosk system as recited in claim 15, wherein the custom construction project is a kitchen remodel project, and the customer-selected construction materials comprise cabinets and countertops.

21. A kiosk system configured to automatically generate a quote for a custom kitchen remodel project, the kiosk system comprising:
a cabinet;
a plurality of compartments at least partially positioned within the cabinet;
a plurality of samples of kitchen cabinet materials stored within the compartments; and
a touch screen monitor positioned on a surface of the cabinet, the touch screen monitor configured to:
i) present an image corresponding to each sample kitchen cabinet construction material;
ii) allow a customer to select one or more of the images presented on the touch screen monitor for use in a custom kitchen remodel project and, in response to the selection, present the customer with a visual indication of the compartments in which the corresponding samples are stored;
iii) send, to a web server, data corresponding to the customer-selected kitchen cabinet materials;
iv) receive, from the web server, an automatically generated cost quote for the custom kitchen remodel project;
v) display the quote on the touch screen monitor;
vi) allow the customer to specify additional data corresponding to a customer-specified layout for the custom kitchen remodel project;
vii) send, to the web server, the additional data;
viii) receive, from the web server, an updated cost quote for the custom kitchen remodel project that was automatically generated using the additional data; and
ix) display the updated quote on the touch screen monitor.

22. The kiosk system as recited in claim 21, further comprising:
a second monitor employed in connection with the touch screen monitor, wherein when a customer selects one of the images presented on the touch screen monitor, the second monitor is configured, in response to the selection, to present the customer with a tutorial regarding manufacture of the corresponding construction material.

23. The method as recited in claim 21, wherein the cost quote comprises a range of cost values for a dealer as well as a range of cost values for a competitor of the dealer.
